(19) United States
(12) Patent Application Publication
(10) Pub. No.: US 2014/0163894 A1
(43) Pub. Date: Jun. 12, 2014

(54) MOTIF FINDING PROGRAM, INFORMATION PROCESSOR AND MOTIF FINDING METHOD

(71) Applicant: SONY CORPORATION, TOKYO (JP)

(72) Inventors: Natalia Polouliakh, Tokyo (JP); Hiroaki Kitano, Saitama (JP)

(73) Assignee: SONY CORPORATION, TOKYO (JP)

(21) Appl. No.: 14/091,727

(22) Filed: Nov. 27, 2013

(30) Foreign Application Priority Data
Dec. 5, 2012 (JP) 2012-266438

(51) Int. Cl. G06F 19/18; G06F 17/18

(52) U.S. Cl. CPC G06F 19/18; G06F 17/18
USPC 702/19

(57) ABSTRACT

A motif finding program is configured to enable an information processor to function as an extraction unit, an alignment unit, a calculation unit and a determination unit. The extraction unit extracts a plurality of sequence fragments as ortholog candidates upstream of the respective transcriptional start sites in DNA sequences of a species of interest and species for comparison. The alignment unit aligns the sequence fragments. The calculation unit calculates a first statistics based on a likelihood ratio of the likelihood that the sequence fragments are orthologous versus the likelihood that they are non-orthologous; and a second statistics representing a degree of conservation among the sequence fragments. The determination unit determines transcription factor binding site motif candidates in a sequence fragment of the species of interest, on the basis of the first statistics and the second statistics.

### CROSS REFERENCES TO RELATED APPLICATIONS

The present application claims priority to Japanese Priority Patent Application JP 2012-266438 filed in the Japan Patent Office on Dec. 5, 2012, the entire content of which is hereby incorporated by reference.

### BACKGROUND

The present disclosure relates to a motif finding program, an information processor and a motif finding method to find transcription factor binding sites.

From the past, in the field of systems biology using computers, some attempts have been made to analyze networks of metabolic regulation system, signal transduction system, and the like that make up a biological system. Various proteins to make up these networks are produced by gene transcription and translation. The gene transcription is regulated when a transcription factor (a set of proteins that binds to specific DNA sequences) binds to a transcriptional regulatory region which is located upstream from the transcriptional start site. Transcriptional regulatory regions contain transcription factor binding motifs (TFBS) recognized by transcription factors and bind the transcription factors. It has been known that the same or similar motifs bind the same kind of transcription factors.

In higher eukaryotes, known transcriptional regulatory regions to which transcription factors bind are represented by the “promoter region” located in relatively close proximity to the transcriptional start site, which promoter region contains a specific sequence, and the “enhancer region” located at some distance from the transcriptional start site (see S. Serizawa, K. Miyamichi, H. Nakatani, M. Suzuki, M. Saito, Y. Yoshihara and H. Sakano, “Negative Feedback Regulation Ensures the One Receptor-One Olfactory Neuron Rule in Mouse”, Science, Vol. 19, 2088-2094 (2003)). Accordingly, it would be possible, by accurately finding the transcription factor binding motifs existing in these regions, to identify transcription factor binding sites. For example, in US Patent publication 2002/0037519 A1, there is described a method of identifying transcription factor binding sites which repetitively appear in the sequence of human DNA. In Japanese Patent Application Laid-Open No. 2007-108949, there is described a method of finding transcriptional control sequence motif of prokaryotes. In addition to that, various motif finding tools are described by the following non-patent documents: M. Muller, K. Hagstrom, H. Gyurkovics, V. Pirrotta and P. Schell, “The Mcp Element From The Drosophila Bithoral Complex Mediates Long-Distance Regulatory Interactions”, Genetics, Vol. 153, 1333-1356 (1999); N. Polouliakh, T. Takagi, and K. Nakai, “MELINA: motif extraction from promoter regions of potentially co-regulated genes”, Bioinformatics, Vol. 19(3), 423-424 (2003); N. Polouliakh, M. Konno, P. Horton and K. Nakai, “Parameter Landscape Analysis for common motif discovery programs”, Lecture Notes in Computer Science, Vol. 3318, Regulatory Genomics, p. 79-87. (2005); D. L. Corcoran, E. Feingold and P. V. Benos, “FOOTER: a web tool for finding mammalian DNA regulatory regions using phylogenetic footprinting”, Nucl. Acids Res., Vol. 33, W442-W446. (2005); S. Sinha, M. Blanchette and M. Tompa, “PhyMe: A Probabilistic algorithm for finding motifs in sets of orthologous sequences.”, BMC Bioinformatics Vol 5: 170 (2004); and R. Siddharthan, E. D. Siggia and E. Nimwegen, “PhyloGibbs: A Gibbs Sampling Motif Finder that Incorporates Phylogeny”, PLoS Computational Biology, V.1(7), e67 (2005).

### SUMMARY

However, the method of identifying transcription factor binding sites described in US Patent publication 2002/0037519 A1 deals with the similarities among the sequences that appear within the human DNA sequence, which means the DNA sequence in a single species, so the method was not able to accurately extract the short motifs whose similarities were hard to determine. The motif finding method described in Japanese Patent Application Laid-Open No. 2007-108949 is a method using the DNA sequence in a prokaryotic species such as Escherichia coli, so it was difficult to directly apply the method to human and other higher eukaryotes since their transcriptional control mechanisms are different. Further, although with reference to the non-patent documents mentioned above, it has been difficult to accurately find the motifs in higher eukaryotes which have complicated transcriptional control mechanisms.

In view of the above-mentioned circumstances, it is desirable to provide a motif finding program, an information processor and a motif finding method capable of accurately finding transcription factor binding site motifs.

According to an embodiment of the present disclosure, there is provided a motif finding program for enabling an information processor to function as an information processor including an extraction unit; an alignment unit; a calculation unit; and a determination unit.

The extraction unit is configured to extract a plurality of sequence fragments as ortholog candidates upstream of the respective transcriptional start sites in a DNA sequence of a species of interest and DNA sequences of at least one species for comparison.

The alignment unit is configured to perform alignment on the plurality of sequence fragments.

The calculation unit is configured to calculate, using the result of the alignment, a first statistics and a second statistics. The first statistics is based on a likelihood ratio of the likelihood that assumes the plurality of sequence fragments is orthologous versus the likelihood that assumes the plurality of sequence fragments is non-orthologous. The second statistics represents a degree of conservation among the plurality of sequence fragments.

The determination unit is configured to determine, based on the first statistics and the second statistics, transcription factor binding site motif candidates in a sequence fragment of the species of interest.

The motif finding program finds the motifs by using the ortholog candidates between the species of interest and the species for comparison. This enables it to accurately find a motif as a sequence that originates from a common ancestral gene and has been evolutionarily conserved. Further, with the first statistics above, it is able to find a sequence region in consideration of not only the degree of conservation of the sequence itself but also the probability of being an ortholog, so the accuracy of retrieval can be improved further.

For example, the determination unit may determine, as a transcription factor binding site motif candidate, a sequence region in which a sum of the first statistics and the second statistics is greater than a predetermined value.

This enables it to easily determine the motif candidates on the basis of the first statistics and the second statistics.

The first statistics may be represented by the logarithm of the likelihood ratio.

This allows calculating the logarithm of the likelihood ratio, using the laws of logarithms, by subtraction of the logarithm of the likelihood with the assumption of orthologous and that of the likelihood with the assumption of non-orthologous. Thus, the calculation of the first statistics can be easily performed.

Specifically, the first statistics may be represented by Formula 1:

$$MAscore - {log}_{10} \frac{Pr g 1 * Pr g 2 * Pr g 3 … Pr gn}{Pr r 1 * Pr r 2 * Pr r 3 * Pr rn} - {log}_{10} \frac{{\prod }_{m}^{ } Pr ( c \vert good\_alignment )}{{\prod }_{m}^{ } Pr ( c \vert random\_alignment )} ,$$

where c is a pattern of arrangement in each column within a matrix when each of the aligned sequence fragments is an arrangement in a row; and m is a length of the aligned sequence.

Further, the second statistics may be represented by occurrence frequencies of the respective nucleotides in the sequence fragment of the species of interest, calculated based on position specific scoring matrices on the result of the alignment.

This allows the second statistics to represent the degree of conservation of the sequence fragment of the species of interest against the sequence fragment of the species for comparison.

The species of interest may be human.

This enables it to accurately find a human transcription factor binding site. Therefore, drug discovery for humans, toxicity study of chemical substances to humans, and the like, would be possible with the use of the motif finding program.

Further, the species for comparison may be mouse and rat.

Since a mouse and a rat are moderately evolutionarily distant from human, their motifs as the sequences important for the biological system are highly conserved as orthologs. Therefore, by extracting the orthologs of human, mouse, and rat, it can accurately extract the motifs.

The alignment unit may have a first alignment unit and a second alignment unit.

The first alignment unit is configured to perform alignment on each two sequence fragments including the sequence fragment of the species of interest.

The second alignment unit is configured to perform multiple alignment on all the plurality of sequence fragments, based on the result of the alignment by the first alignment unit.

This allows the multiple alignment using the result of the pairwise alignment being performed on each two sequence fragments, so the multiple alignment can be performed efficiently.

Further, the plurality of sequence fragments may include promoter regions.

This enables it to find motifs from transcriptional regulatory regions, so the accuracy of finding motifs can be improved further.

According to another embodiment of the present disclosure, there is provided an information processor including an extraction unit; an alignment unit; a calculation unit; and a determination unit.

The extraction unit is configured to extract a plurality of sequence fragments as ortholog candidates upstream of the respective transcriptional start sites in a DNA sequence of a species of interest and DNA sequences of at least one species for comparison.

The alignment unit is configured to perform alignment on the plurality of sequence fragments.

The calculation unit is configured to calculate, using the result of the alignment, a first statistics and a second statistics. The first statistics is based on a likelihood ratio of the likelihood that assumes the plurality of sequence fragments is orthologous versus the likelihood that assumes the plurality of sequence fragments is non-orthologous. The second statistics represents a degree of conservation among the plurality of sequence fragments.

The determination unit is configured to determine, based on the first statistics and the second statistics, transcription factor binding site motif candidates in a sequence fragment of the species of interest.

According to still another embodiment of the present disclosure, there is provided a motif finding method which includes extracting a plurality of sequence fragments as ortholog candidates upstream of the respective transcriptional start sites in a DNA sequence of a species of interest and DNA sequences of at least one species for comparison.

The plurality of sequence fragments is aligned.

Using the result of the alignment, a first statistics and a second statistics are calculated. The first statistics is based on a likelihood ratio of the likelihood that assumes the plurality of sequence fragments is orthologous versus the likelihood that assumes the plurality of sequence fragments is non-orthologous. The second statistics represents a degree of conservation among the plurality of sequence fragments.

Transcription factor binding site motif candidates in a sequence fragment of the species of interest are determined based on the first statistics and the second statistics.

As described above, the embodiments of the present disclosure make it possible to provide a motif finding program, an information processor and a motif finding method capable of accurately finding transcription factor binding site motifs.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic diagram showing a configuration of an information processing system including an information processor according to the embodiment;

FIG. 2 is a flowchart showing a motif finding method according to the embodiment;

FIG. 3 is a figure showing an example of a user interface for receiving, from a user, a query of DNA data to be searched for;

FIGS. 4A to 4C are some examples of display of the sequence fragments that include promoter regions of a known gene, extracted by the extraction unit shown in FIG. 2; FIG. 4A showing the sequence fragment of a species of interest (for example, human), FIG. 4B showing the sequence fragment of a first species for comparison (for example, mouse), and FIG. 4C showing the sequence fragment of a second species for comparison (for example, rat);

FIG. 5 is a figure showing an example of the result of multiple alignment, by the alignment unit shown in FIG. 2, of the sequence fragment of the species of interest aligned to the sequence fragments of the first and the second species for comparison;

FIG. 6 is a part of a table showing occurrence probabilities, calculated by the calculation unit shown in FIG. 2, of each pattern of arrangement c in each column within a matrix when each of the aligned sequence fragments is an arrangement in a row, which shows an example of the occurrence probabilities in an orthologous sequence fragment and those in a random sequence fragment;

FIG. 7 is a graph showing an example of the calculated result, by the calculation unit shown in FIG. 2, which is a case of the sequence upstream of the transcriptional start site of the epidermal growth factor receptor (EGFR) gene; where the number of nucleotides (distance) from TSS (transcriptional start site) is taken along the abscissa, and the score calculated for each position in the sequence fragment is taken along the ordinate;

FIG. 8 is a graph showing an example of the calculated result, by the calculation unit shown in FIG. 2, which is a case of the sequence upstream of the TSS of the neuropeptide Y (NPY) gene; where the number of nucleotides (distance) from TSS is taken along the abscissa, and the score calculated for each position in the sequence fragment is taken along the ordinate;

FIG. 9A is a schematic drawing showing a typical example in which many DNA-binding proteins (transcription factors) are bound to the transcriptional regulatory region in a higher eukaryote, which shows a case of the G-protein coupled odorant receptor gene; and

FIG. 9B is a figure explaining where the enhancer region is located at, which shows a case of the MOR28 gene cluster in a mouse.

### DETAILED DESCRIPTION

Hereinafter, an embodiment of the present disclosure will be described with reference to the drawings.

[Configuration of Information Processing System]

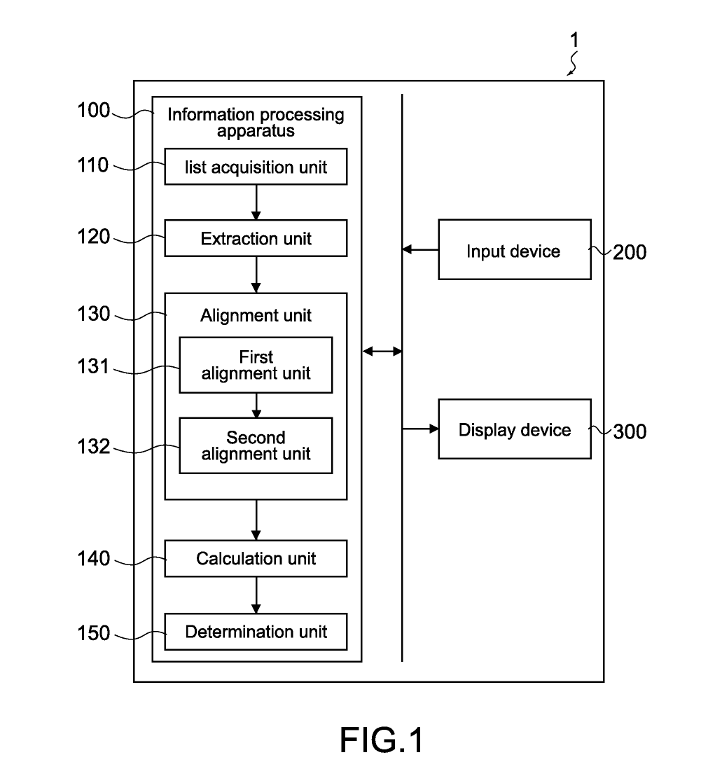

FIG. 1 is a schematic diagram showing a configuration of an information processing system 1 according to this embodiment. The information processing system 1 has an information processor 100, input device 200, and a display device 300.

The information processor 100 is configured to be capable of finding transcription factor binding site motifs on the basis of a user's input. The information processor 100 may be made up, for example, of various computers such as a server, a personal computer, and a tablet terminal. Further, the information processor 100 is connected to the input device 200 and the display device 300.

The input device 200 is configured to be capable of receiving an input from the user. The input device 200 in this embodiment is made up, for example, of a keyboard, a touch panel display, or the like. The input device 200 is configured, as will be described later, to be capable of receiving the user's input of the DNA data to be searched for, and the like.

The display device 300 includes a display and the like, for example, and is configured to be capable of showing the user the result of determination of motif candidates. Further, the display device 300 may be configured to be capable of showing also an input reception image, data of sequences of ortholog candidates, result of alignment, result of calculation of first and second statistics, and the like, each of which will be described later.

Next, a configuration of the information processor 100 will be described.

[Configuration of Information Processor]

The information processor 100 has a list acquisition unit 110, an extraction unit 120, an alignment unit 130, a calculation unit 140 and a determination unit 150.

The list acquisition unit 110 creates a list by obtaining a plurality of sequence regions as “ortholog candidates” from a DNA sequence to analyze. The term “ortholog” means homologous genes that have originated from a common ancestral gene, among a plurality of groups of organisms of the different species. The list acquisition unit 110 in this embodiment is capable of obtaining a plurality of sequence regions as ortholog candidates from DNA sequences of the species to investigate (hereinafter, species of interest) and of two species to be compared with that species (hereinafter, species for comparison). Hereinafter, a DNA sequence of the species of interest will be referred to as a “sequence of interest” and the DNA sequences of the two species for comparison will be referred to as “first sequence for comparison” and “second sequence for comparison”.

In addition, in this embodiment, the species of interest is “human” and the species for comparison are “mouse” and “rat”. In other words, the sequence of interest is a human DNA sequence and the sequences for comparison are rat and mouse DNA sequences. The combination of the species of interest and the species for comparison is not limited to this, but this combination may be suitable for the reason to be described later.

The list acquisition unit 110 provides the created list of the ortholog candidates to the extraction unit 120.

The extraction unit 120 is capable of extracting, based on the list provided by the list acquisition unit 110, a plurality of sequence fragments as ortholog candidates upstream of the respective transcriptional start sites in the sequence of interest, in the first sequence for comparison and in the second sequence for comparison. The sequence fragments that the extraction unit 120 has extracted from the sequence of interest, the first sequence for comparison, and the second sequence for comparison will be respectively referred to as “sequence fragment of interest”, “first sequence fragment for comparison”, and “second sequence fragment for comparison”.

The extraction unit 120 provides the extracted sequence fragment of interest, first sequence fragment for comparison, and second sequence fragment for comparison to the alignment unit 130.

The alignment unit 130 is capable of performing alignment on a plurality of sequence fragments provided from the extraction unit 120. The term “alignment” means aligning DNA sequences or the like in such a manner that the identical or similar parts of sequences are aligned in columns so as to allow the comparison of each DNA sequence or the like against each other. The alignment unit 130 has a first alignment unit 131 and a second alignment unit 132.

The first alignment unit 131 is capable of performing alignment on each two sequence fragments including the sequence fragment of the species of interest extracted by the extraction unit 120. In other words, the first alignment unit 131 performs each alignment (pairwise alignment) between the sequence fragment of interest and the first sequence fragment for comparison, and between the sequence fragment of interest and the second sequence fragment for comparison.

The second alignment unit 132 is capable of performing alignment (multiple alignment) among the three, of the sequence fragment of interest, the first sequence fragment for comparison, and the second sequence fragment for comparison, based on the result of the alignment by the first alignment unit 131. In other words, the second alignment unit 132 is capable of performing multiple alignment on all the plurality of sequence fragments extracted by the extraction unit 120.

The alignment unit 130 provides the result of the alignment by the first and alignment unit 131 and the second alignment unit 132 to the calculation unit 140.

The calculation unit 140 calculates, using the result of the alignment by the alignment unit 130, a first statistics (see below) which is based on a likelihood ratio of the “likelihood” that assumes the plurality of sequence fragments is orthologous versus the “likelihood” that assumes the plurality of sequence fragments is non-orthologous, and a second statistics (see below) which represents a degree of conservation among the plurality of sequence fragments. The term “likelihood” means an index of plausibility to assume that a precondition was X when a result was Y, by reversing the cause-and-effect relationship, in the case where the result Y is observed following a certain precondition X. The calculation unit 140 provides the first and the second statistics to the determination unit 150.

The determination unit 150 determines, based on the first statistics and the second statistics, transcription factor binding site motif candidates in the sequence fragment of interest. The determination unit 150 outputs the determined data of the motif candidates to the display device 300, and allows it to show them to the user.

The units described above may be caused to execute the process in accordance with a program written in a programming language such as C language, Perl language, and Java (registered trademark). For example, the process may be executed by “SHOE (Sequence HOmology in Higher eukaryotes)” which is a program developed by the present inventors.

In the following, an operation of the information processor will be described.

[Operation of Information Processor]

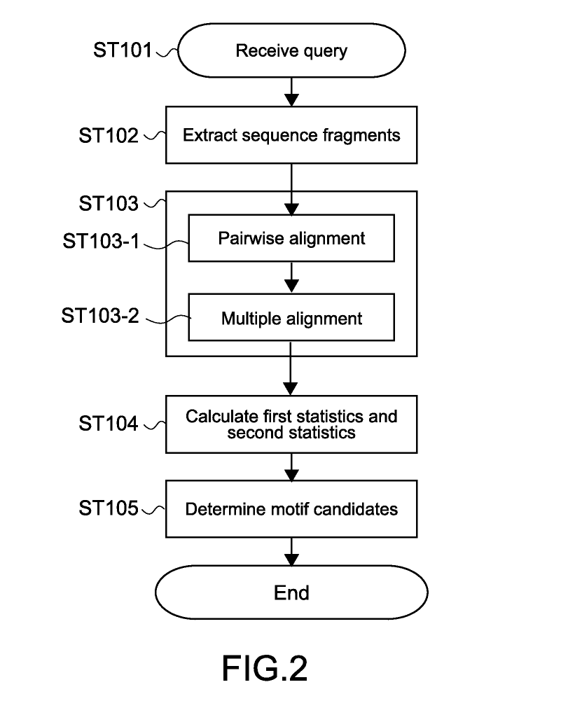

FIG. 2 is a flowchart showing a transcription factor binding site motif finding method according to this embodiment. The motif finding method according to this embodiment includes receiving query from a user; extracting a plurality of sequence fragments as ortholog candidates; performing alignment on the plurality of sequence fragments; calculating the first and the second statistics; and determining motif candidates. In the following, each of the processes above will be described.

(Receiving Query)

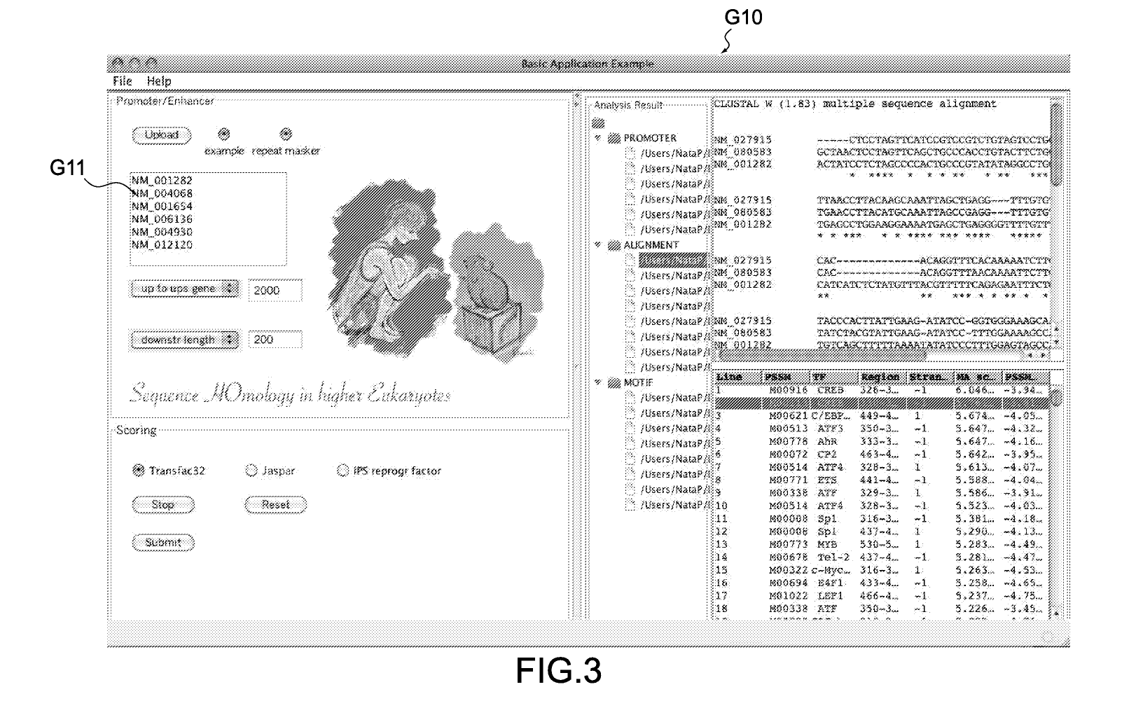

The extraction unit 120 receives, from the user, a query of DNA data (query DNA data) of the transcriptional regulatory region that the user wishes to search motifs of (ST101). The display device 300 may show the user, for example, an image G10 as shown in FIG. 3. In this case, the extraction unit 120 is able to process, as the query DNA data, the information filled in an entry field G11 by the user using the input device 200. Such a user interface as the image G10 may be written in Java (registered trademark), for example.

The query DNA data may be, for example, information on a known gene whose transcriptional control may be mediated by the transcriptional regulatory region that the user wishes to search motifs of. Specifically, the query DNA data may be Gene IDs such as “MAPK1” and “POUF5F1”, or Refseq IDs such as “NM_{—}002745” and “NM_{—}002701” provided by NCBI (National Center for Biotechnology Information) (see http://www.ncbi.nlm.nih.gov/index.html).

(Extracting Plurality of Sequence Fragments)

The extraction unit 120 extracts, based on the query DNA data, the sequence fragment of interest, the first sequence fragment for comparison, and the second sequence fragment for comparison, each from the list created by the list acquisition unit 110 (ST102). That is, the extraction unit 120 is able to extract a plurality of sequence fragments as ortholog candidates from the regions including promoter and enhancer regions upstream of the respective transcriptional start sites in the sequence of interest, in the first sequence for comparison and in the second sequence for comparison.

The extraction unit 120 in this embodiment is able to extract the sequence fragment of interest, the first sequence fragment for comparison, and the second sequence fragment for comparison, based on query DNA data of at least one of the species of interest and the species for comparison.

Further, the extraction unit 120 may be configured to be capable of extracting from the list created by the list acquisition unit 110, based on predetermined conditions. Examples of the predetermined conditions include distance from the transcriptional start site of a known gene used as the query; and length of the sequence fragments to be extracted. Since the extraction unit 120 extracts the sequence fragments from the list previously created by the list acquisition unit 110, a wide range of the “predetermined conditions” is allowable. Therefore, for example, the promoter regions and the enhancer regions may be specified together.

The predetermined conditions may be programmed in advance, or may be specified by the user. In the case where the predetermined conditions are allowed to be specified by the user, it may be configured so that the user can specify them at the time of query of the DNA data.

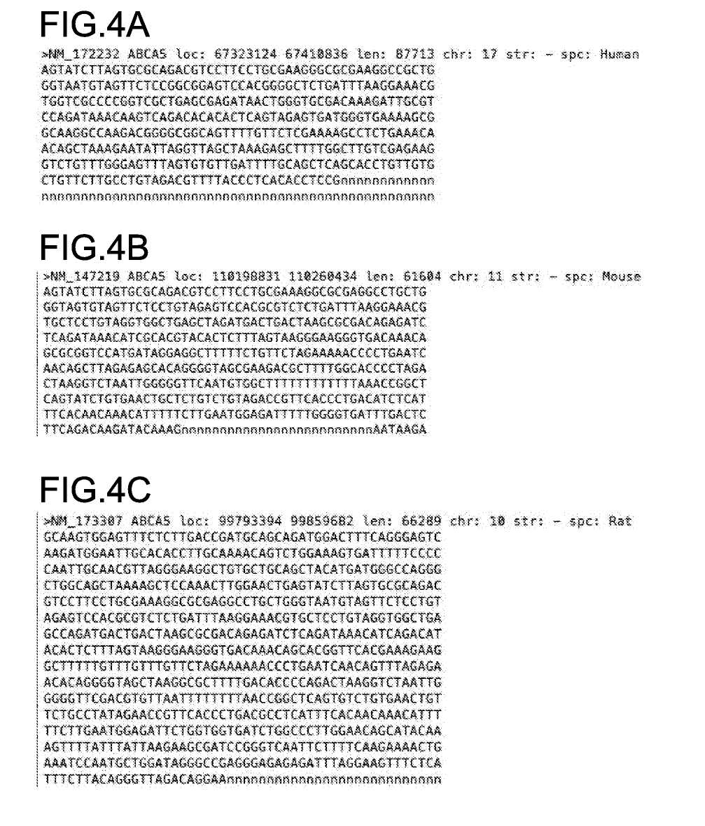

The display device 300 may display the sequence fragments extracted by the extraction unit 120, as shown in FIGS. 4A to 4C. FIGS. 4A to 4C are some examples of display of the sequence fragments shown in FASTA text format, the sequence fragments including promoter regions of a known gene. FIG. 4A shows the sequence fragment of interest (human, as an example), FIG. 4B shows the first sequence fragment for comparison (mouse, as an example), and FIG. 4C shows the second sequence fragment for comparison (rat, as an example). The display of the sequence fragments is not limited to FASTA text format, but also other formats may be employed.

In the case where the result of extraction is displayed by the display device 300, it may be configured so that the user can select whether or not to use a program such as Repeat Masker, for displaying or not displaying “repeat sequences”. In the case where Repeat Masker is used, all the repeat sequences are shown by “n”.

(Performing Alignment on Plurality of Sequence Fragments)

Next, the alignment unit 130 performs alignment on the plurality of sequence fragments extracted by the extraction unit 120 (ST103). In this embodiment, first, the first alignment unit 131 performs pairwise alignment (ST103-1). Then, the second alignment unit 132 performs multiple alignment based on the result of the alignment by the first alignment unit 131 (ST103-2). This enables the multiple alignment based on the result such as degree of sequence identity obtained from the pairwise alignment, which allows the computational complexity to be reduced.

The first alignment unit 131, in this embodiment, performs each pairwise alignment between the sequence fragment of interest and the first sequence fragment for comparison, and between the sequence fragment of interest and the second sequence fragment for comparison. The first alignment unit 131 may perform the alignment in accordance with an existing program such as SSEARCH (Smith-Waterman local alignment algorithm) (FASTA v34 suite), for example.

Next, the second alignment unit 132 performs multiple alignment among the three, of the sequence fragment of interest, the first sequence fragment for comparison, and the second sequence fragment for comparison, based on the result of the alignment by the first alignment unit 131. The second alignment unit 132 may perform the alignment in accordance with an existing program such as Clustal W. The result of this alignment can be represented by a 3-by-n matrix which has a sequence fragment of the sequence length n along the horizontal direction (row) being aligned.

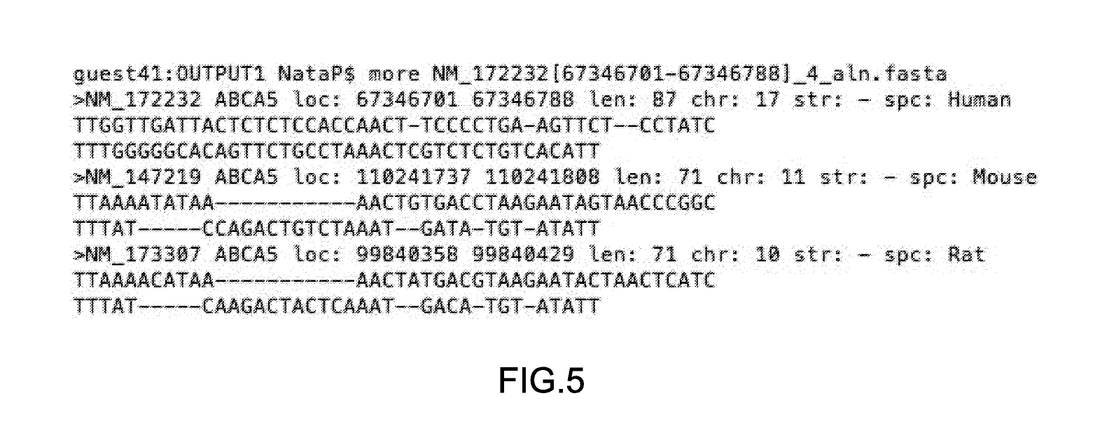

The display device 300 may display the result of the alignment by the alignment unit 130, as shown in FIG. 5. FIG. 5 shows an example of the result of multiple alignment of the sequence fragment of interest aligned to the first and the second sequence fragments for comparison. In FIG. 5, in order to make each sequence fragment aligned with each other, there are gaps represented as hyphens being inserted in the sequence fragments.

(Calculating First and Second Statistics)

Subsequently, the calculation unit 140 calculates, using the result of the alignment, the first statistics which is based on a likelihood ratio of the likelihood that assumes the plurality of sequence fragments is orthologous versus the likelihood that assumes the plurality of sequence fragments is non-orthologous, and the second statistics which represents a degree of conservation among the plurality of sequence fragments (ST104). In this embodiment, the first statistics is referred to as “MA score (multiple alignment score)”, and the second statistics is referred to as “PM score (PSSM score: Position Specific Scoring Matrices score)”.

First, the calculation unit 140 calculates the MA score. The MA score is a value which serves as an index of probability of being an ortholog. The MA score is represented by the following Formula 1.

$$MAscore - {log}_{10} \frac{Pr g 1 * Pr g 2 * Pr g 3 … Pr gn}{Pr r 1 * Pr r 2 * Pr r 3 * Pr rn} - {log}_{10} \frac{{\prod }_{m}^{ } Pr ( c \vert good\_alignment )}{{\prod }_{m}^{ } Pr ( c \vert random\_alignment )} , \qquad ( Formula 1 )$$

Herein, provided that the result of the alignment is represented as a matrix, c is a pattern of arrangement in each column within the matrix when each of the aligned sequence fragments is an arrangement in a row, and m is a length of the aligned sequence.

A denominator of an antilogarithm, in the formula above, shows the likelihood Prr that assumes the sequence fragment of interest, the first sequence fragment for comparison, and the second sequence fragment for comparison are non-orthologous, in random alignment. In other words, it shows the probability of occurrence of a pattern of arrangement in each column when each of the aligned sequence fragments is an arrangement in a row, with the assumption that the plurality of sequence fragments is in random alignment. Specifically, the term “pattern of arrangement” means a pattern of arrangement made by extracting one nucleotide each from the sequence fragment of interest, the first sequence fragment for comparison, and the second sequence fragment for comparison, each of which nucleotide is arranged in a common column. In this embodiment, for example, the pattern of arrangement is made up of three nucleotides. A numerator shows the likelihood Prg that assumes the sequence fragment of interest is an ortholog (good alignment). In other words, it shows the probability of occurrence of a pattern of arrangement in each column when each of the aligned sequence fragments is an arrangement in a row, with the assumption that the plurality of sequence fragments is orthologous.

First, a method of calculating the likelihood Prg and the likelihood Prr will be described. As a preparation for the calculation of the likelihood Prg first, a sequence fragment of a known promoter region which is orthologous to each other is extracted from each of the sequence of interest, the first sequence for comparison, and the second sequence for comparison (see ST102). Hereinafter, regarding the three sequence fragments each of which is extracted from the corresponding one of the sequence of interest, the first sequence for comparison, and the second sequence for comparison, a set of sequence fragments of the three will be referred to as “set of sequence fragments”. Then, the set of sequence fragments is subjected to multiple alignment (see ST103). These processes above are performed again on another different set of sequence fragments. Thus, the result of alignment of a plurality of sets of sequence fragments is obtained. Then, the probability of occurrence of each pattern of arrangement in each column, when the result of the above-described alignment is represented as a matrix, is calculated.

Meanwhile, as a preparation for the calculation of the likelihood Prr, a set of sequence fragments is extracted randomly to have each sequence fragment from the sequence of interest, the first sequence for comparison, and the second sequence for comparison (see ST102); and the extracted set of sequence fragments is subjected to multiple alignment (see ST103). The subsequent processes are performed in the same manner as in the case of the likelihood Prg. In other words, the processes up to multiple alignment are performed again on another different set of sequence fragments, and thus the result of alignment of a plurality of sets of sequence fragments is obtained. Then, the probability of occurrence of each pattern of arrangement in each column, when the result of the above-described alignment is represented as a matrix, is calculated. In order to randomly extract a set of sequence fragments, for example, a random number generator program such as Numerical Recipes Book may be used.

An example of the method of calculating the likelihood Prg and the likelihood Prr is illustrated below. First, in order to calculate the likelihood Prg, in 7,000 genes common among the sequence of interest, the first sequence for comparison, and the second sequence for comparison, the sequence regions from the respective transcriptional start sites to 5,000 bp (base pairs) upstream thereof in the sequence of interest, in the first sequence for comparison and in the second sequence for comparison were extracted. From these sequence regions, 835 sets of sequence fragments as ortholog candidates were extracted. Then, each set of sequence fragments was subjected to alignment. The plurality of sets of sequence fragments was with total sequence length of 238,000 nt (nucleotides). The average length of successfully aligned sequences was 285 nt.

Meanwhile, in order to calculate the likelihood Prr, some sequence fragments were randomly extracted from the upstream regions of the 7,000 genes which were used for the calculation of the likelihood Prg; and the extracted 1,260 sets of sequence fragments, making total sequence length of 239,600 nt, were each subjected to alignment. The length of successfully aligned sequences in average was 190 nt. That is, in this example, the length of successfully aligned sequences of random alignment was approximately 100 nt shorter than that of orthologous alignment.

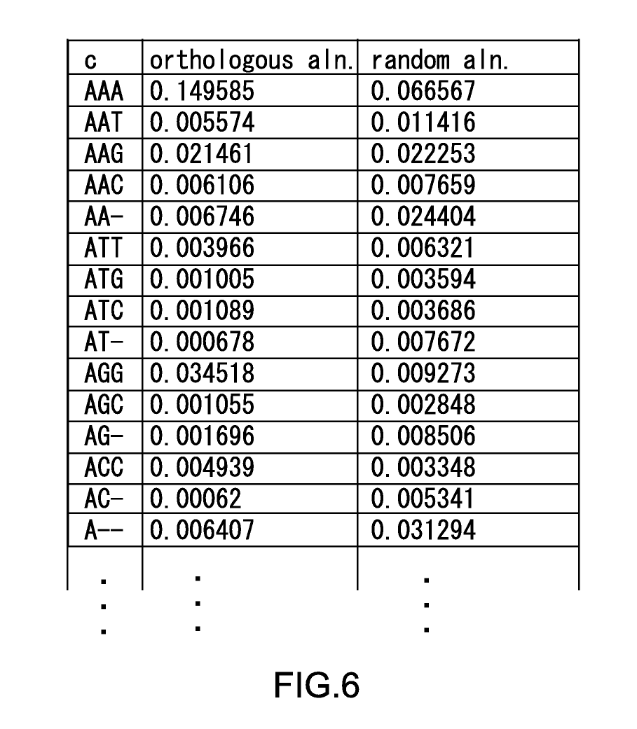

FIG. 6 is a part of a table showing occurrence probabilities of each pattern of arrangement c in each column (see Formula 1) within a matrix when each of the aligned sequence fragments is an arrangement in a row, which shows an example of the occurrence probabilities in an orthologous sequence fragment and those in a random sequence fragment, of the example illustrated above. As shown in FIG. 6, the probability assigned to each pattern of arrangement is calculated.

Subsequently, the calculation unit 140 applies the calculated probability assigned to each pattern of arrangement to the sequence fragments aligned by the alignment unit 130, so that the assigned probabilities are applied to each pattern of arrangement in each column within a matrix when each of the aligned sequence fragments is an arrangement in a row, thereby calculating the likelihood Prg and the likelihood Prr on a desired sequence region. Then, by calculating the likelihood ratio between them, and further calculating the logarithm of this likelihood ratio, the MA score of Formula 1 would be calculated. In the case where the resulting value of Formula 1 is negative, the absolute value of Formula 1 may be employed as the MA score.

By thus defining the MA score by the logarithm of the likelihood ratio, it is made possible to calculate the logarithm of the likelihood ratio, using the laws of logarithms, by subtraction of logarithms of the respective values of likelihood. Thus, the calculation of the MA score can be easily performed.

Next, the calculation unit 140 calculates the PM score. The PM score is represented by occurrence frequencies of the respective nucleotides in the sequence fragment of the species of interest, calculated based on position specific scoring matrices (PSSMs) on the result of the alignment. Specifically, the PM score is represented by the following Formula 2.

$$PMscore = {\sum }_{i = 1}^{m} {log}_{2} \frac{{count}_{{x}_{i}} + {pseudocount}_{{x}_{i}}}{{\sum }_{x = A , T , G , C}^{ } {count}_{{x}_{i}} + {\sum }_{x = A , T , G , C}^{ } {pseudocount}_{{x}_{i}}} , \qquad ( Formula 2 )$$

Herein, m is a length of the sequence, as in the MA score, “count” is an actual frequency, and “pseudocount” is a pseudo-frequency; in which, as an example, ^{pseudocount}x=1.

The position specific scoring matrices are matrices showing the frequency of occurrence of a nucleotide at each position when the result of the alignment by the alignment unit 130 is regarded as a 3-by-n matrix. The PM score is a value for each column in the first row in the position specific scoring matrix, that is, a value showing the frequency of occurrence of a nucleotide at each position of a sequence fragment of a species of interest (for example, human). From this point, it can be said that the PM score is a value which represents a degree of conservation of the sequence fragment of the species of interest against the sequence fragment of the species for comparison.

(Determining Motif Candidates)

Finally, the determination unit 150 determines, based on the first statistics and the second statistics, transcription factor binding site motif candidates in the sequence fragment of interest (ST105). More specifically, the determination unit 150 determines, as a transcription factor binding site motif candidate, a sequence region in which a sum of the MA score and the PM score is greater than a predetermined value, out of the sequence fragment of the species of interest. By using not only the PM score, which represents the degree of conservation of the nucleotides, but also adding the MA score which represents the probability of being an ortholog, it is made possible to accurately find the motif candidates which have been highly conserved in the course of evolution.

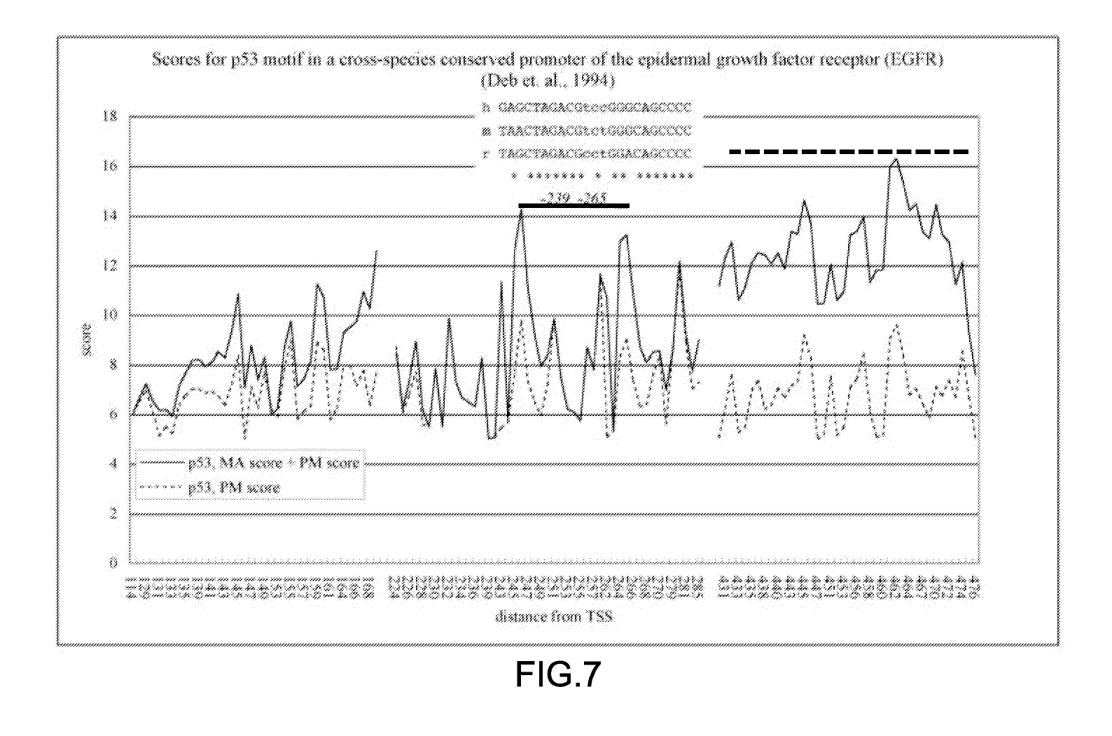

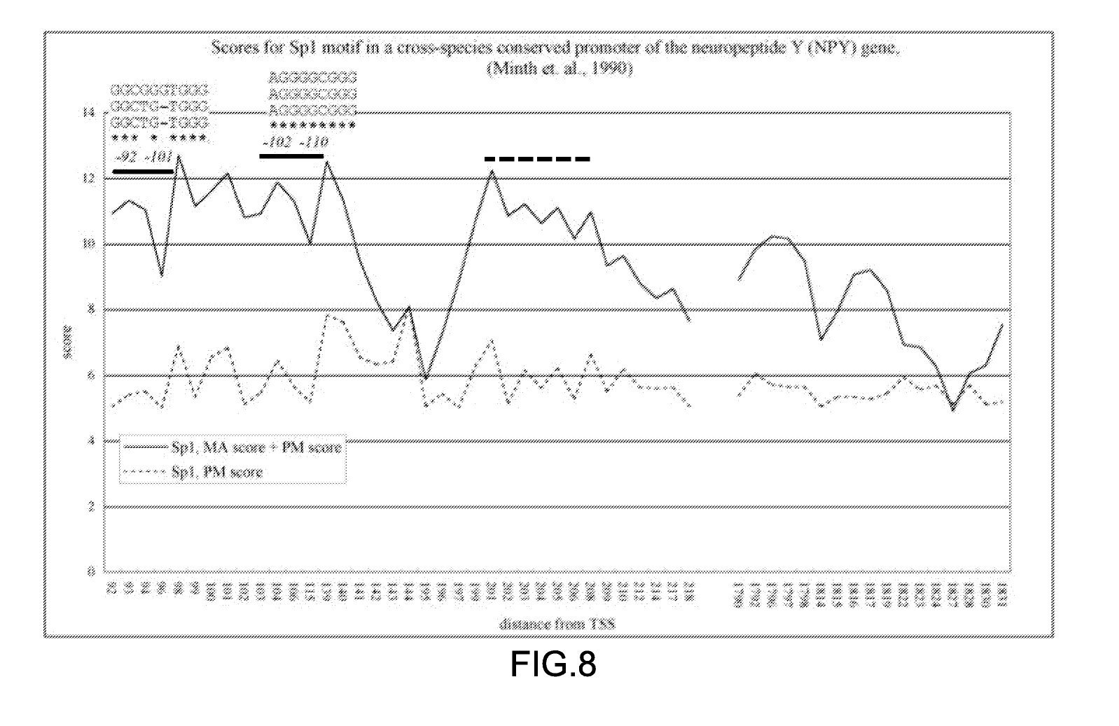

FIGS. 7 and 8 are graphs showing an example of the calculated result, by the calculation unit 140. In both figures, the number of nucleotides (distance) from TSS (transcriptional start site) is taken along the abscissa, and the score calculated for each position in the sequence fragment when m=1 is taken along the ordinate. The solid line represents the sum of MA score and PM score when an absolute value of Formula 1 is employed. The dashed line represents the value of the PM score alone. The disruptions in the solid and dashed lines each represent the borders of the sequence fragments. That is, the graph of FIG. 7 shows the results of three sequence fragments in the regions −114 nt to −168 nt, −224 nt to −285 nt, and −224 nt to −285 nt. The graph of FIG. 7 shows the results of two sequence fragments in the regions −92 nt to −218 nt and −1790 nt to −1831 nt.

FIG. 7 shows an example of the calculated result, by the calculation unit 140, for the sequence upstream of the transcriptional start site of the epidermal growth factor receptor (EGFR) gene. The region shown in thick solid line in the graph represents p53 motif, which is a known motif located within the promoter region of EGFR gene. In the graph of FIG. 7, the PM score shown in the dashed line varies between about 6 and about 8, regardless of the position in the sequence, and a region which shows a specific score is not detected. On the other hand, the sum of MA score and PM score is significantly increased in the region −239 nt to −265 nt, that is, the region where p53 motif is located, and the score of more than 10 is observed, for example.

FIG. 8 shows an example of the calculated result, by the calculation unit 140, for the sequence upstream of the transcriptional start site of the neuropeptide Y receptor (NPY) gene. The regions shown in thick solid line in the graph represent Sp1 motif, which is a known motif located within the promoter region of NPY gene. In the graph of FIG. 8, the PM score shown in the dashed line does not show a significant change, as in the graph of FIG. 7. On the other hand, the sum of MA score and PM score is significantly increased in the regions −92 nt to −101 nt and −102 nt to −110 nt, that is, the regions where Sp1 motif is located, and the score of more than 10 is observed.

As seen from FIGS. 7 and 8, compared to the case of the PM score alone, the sum of MA score and PM score is significantly increased in the sequence region where the known motif exists. In other words, the fact that the sum of MA score and PM score allows accurately finding the motif candidates is confirmed. Further, for example, the region −433 nt to −474 nt shown in thick dashed line in FIG. 7, and the region −199 nt to −208 nt shown in thick dashed line in FIG. 8, can also be inferred to have a motif candidate.

Thus, for each position in the sequence fragment of the species of interest, the determination unit 150 is able to determine, as a transcription factor binding site motif candidate, a sequence region in which a sum of MA score and PM score is, for example, greater than 10 as a predetermined value. Alternatively, the determination unit 150 may determine a motif candidate on the basis of the sum of MA scores and PM scores of a predetermined motif length m. The sum of MA scores and PM scores may greatly depend on the value of m. However, the present inventors have found that a single threshold such as 10 (sum of MA scores and PM scores), as an example, may be sufficient for finding a motif in a limited range of motif lengths such as 5 to 15 nucleotides (average 9 nucleotides). Thus, according to this embodiment, by calculating the sum of MA score and PM score, it is made possible to easily determine the motif candidates.

As described above, the information processor 100 according to this embodiment can accurately find a transcription factor binding site motif candidate, by using not only the sequence of interest but also the orthologs of the first and the second sequences for comparison.

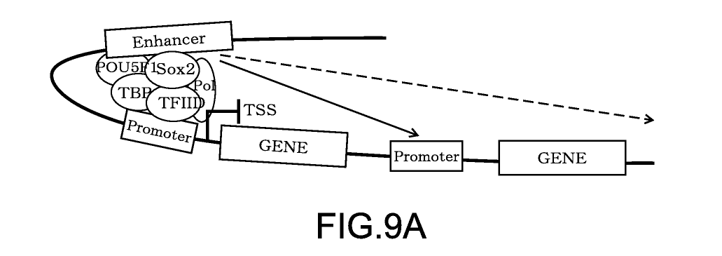

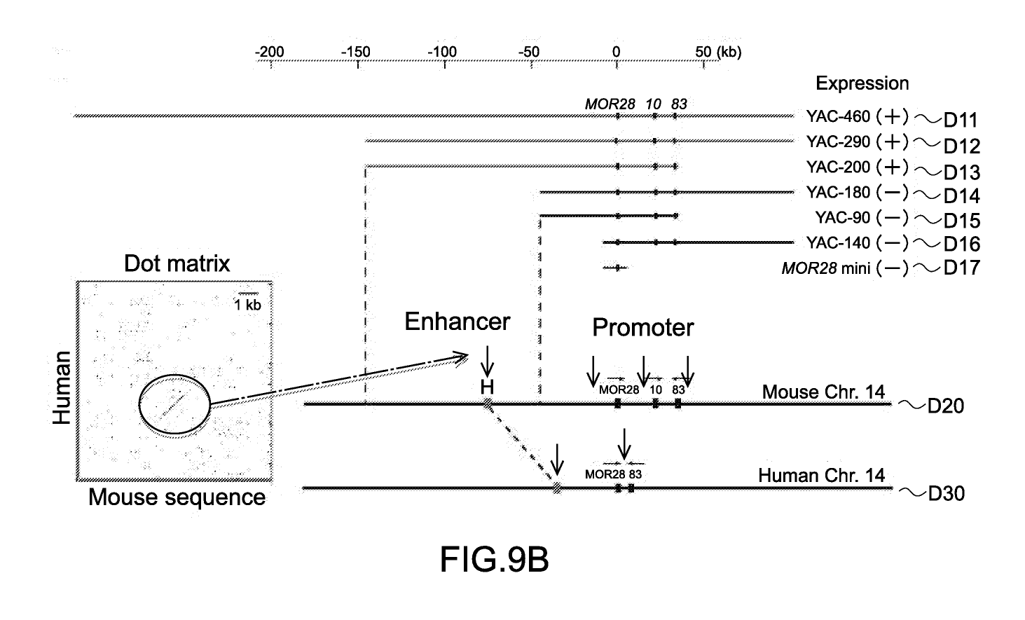

FIG. 9A is a schematic drawing showing a typical example in which many DNA-binding proteins (transcription factors) are bound to the transcriptional regulatory region in a higher eukaryote, which shows a case of the G-protein coupled odorant receptor gene (see the document by S. Serizawa et al., referred above). As shown in the figure, transcriptional regulatory regions in higher eukaryotes include enhancer regions as well as promoter regions, which is different from those of prokaryotes and the like. However, enhancer regions are usually very far away from transcriptional start sites. For example, an enhancer region might be located thousand hundreds base pairs upstream to the transcriptional start site. Accordingly, there are many enhancer regions whose location is not known.

FIG. 9B is a figure explaining where the enhancer region is located at, which shows a case of the MOR28 gene cluster in a mouse (see the document by S. Serizawa et al., referred above). More specifically, FIG. 9B shows the result of an experiment to see if MOR28 gene would be expressed when a plurality of sequence fragments which includes MOR28 gene of a mouse, each of which sequence fragments has a different length of the sequence, was subjected to the action of the transcription factors for the MOR28 gene cluster.

D11 to D17 in FIG. 9B represent seven sequence fragments including MOR28 gene of a mouse, each of which sequence fragments having a different length of the sequence. D11 is a sequence fragment including a sequence region across 200 kb downstream and 50 kb upstream of the transcriptional start site (TSS) (0 kb); D12 is a sequence fragment including a region across approximately 150 kb downstream and 50 kb upstream of the TSS; D13 is a sequence fragment including a region across approximately 150 kb downstream and approximately 30 kb upstream of the TSS; D14 is a sequence fragment including a region across approximately 50 kb downstream and approximately 100 kb upstream of the TSS; D15 is a sequence fragment including a region across approximately 50 kb downstream and approximately 30 kb upstream of the TSS; D16 is a sequence fragment including a region across approximately 10 kb downstream and approximately 50 kb upstream of the TSS; and D17 is a sequence fragment including a region across approximately 10 kb downstream and approximately 10 kb upstream of the TSS. D20 in FIG. 9B represents a sequence region including the MOR28 gene cluster on mouse chromosome 14, while D30 represents a sequence region including the MOR28 gene cluster on human chromosome 14. The downward arrow heads described under the word “Promoter” indicate the locations of the known promoter regions on D20 and D30. Further, “Dot matrix”, which will be described later, is a graph showing the positions of homologous nucleotides between mouse and human DNA sequences, indicated by the dots; where the abscissa represents mouse DNA sequence and the ordinate represents human DNA sequence. In FIG. 9B and the following description, “kb” stands for “1000 bp”.

First, each of D11 to D17 was subjected to the action of the transcription factors for the MOR28 gene cluster. As a result, in D11 to D15, expression of D11, D12, and D13, by binding known DNA binding proteins that bind to the MOR28 gene cluster, was observed (indicated by “+”). However, no expression was observed with D14 or D15 (indicated by “−”). Referring to D20, among these D11 to D17, the sequence fragments that include the known promoter regions are D11 to D15. Thus, the fact that the expression of the MOR28 gene cluster requires not only the promoter region but also the enhancer region existing at the region of more than approximately 50 kb downstream of the TSS can be confirmed. Further, the presence of this enhancer region in a region from approximately 150 kb to approximately 50 kb downstream of the TSS, which region is included in D13 but not included in D14, can also be confirmed.

Incidentally, transcriptional regulatory regions such as promoter regions and enhancer regions have motifs which bind DNA binding proteins. The same or similar motifs bind the same kind of DNA binding proteins. That is, the expression of the genes that are located downstream of the same or similar motifs is likely to be controlled by the same kind of DNA binding proteins. Therefore, by accurately finding a plurality of motifs, it becomes possible to analogize an expression pattern of each gene located downstream of each motif, or the like, using the similarity among the motifs.

Further, since the motifs are the sequence regions having high importance for the biological system, they are highly conserved in the course of evolution. Accordingly, the motifs are likely to be homologous genes that have originated from a common ancestral gene, among a plurality of groups of organisms of the different species, that is, an ortholog.

For example, the case shown in FIG. 9B has investigated the locations of homologous nucleotides between mouse and human DNA sequences including the MOR28 gene cluster in order to find the detail of location of the enhancer region. The graph “Dot matrix” indicates the result. From this graph, the presence of a homologous sequence extending approximately 2 kb on the region approximately 75 kb downstream from the TSS of the MOR28 gene of a mouse can be confirmed. This homologous sequence is the region indicated with the letter “H” on D20 in mouse, and corresponds to the region connected to “H” by the dotted line on D30 in human.

In the case of the MOR28 gene cluster according to FIG. 9B, since the length of the homologous sequence is relatively long, the enhancer region can be estimated simply from the result of “Dot matrix”. However, in the case with shorter homologous sequence, it may be difficult to determine whether it is an evolutionarily conserved ortholog or only an accidental result.

In view of this, the information processer 100 according to this embodiment involves introduction of the first statistics which serves as an index of “probability of being an ortholog”, which allows accurately extracting an ortholog. Thus, it is made possible to reliably extract the transcription factor binding site motifs. Therefore, it is able to find not only the motifs of promoter regions located near the TSSs but also the motifs in enhancer regions which require more reliable evidence.

Further, in this embodiment, while human is the species of interest, mouse and rat are selected as the species for comparison. It has been known that mouse and rat DNA sequences is about 70% identical to human DNA sequence, and that the degree of conservation is especially high in important sequence regions such as transcription factor binding site motifs (see Y. Suzuki, R. Yamashita, M. Shirota, Y. Sakakibara, J. Chiba, J. Mizushima-Sugano, K. Nakai and S. Sugano, “Sequence Comparison of Human and Mouse Genes Reveals a Homologous Block Structure in the Promoter Regions,” Genome Res., 14, 1711-1718 (2004)). On the other hand, in the sequence regions of lower importance, the degree of conservation among human, mouse, and rat DNA sequences tends to be low. Accordingly, since a mouse and a rat, which are rodents, are moderately evolutionarily distant from human, their motifs are able to be accurately extracted, by extraction of their orthologs.

Furthermore, in this embodiment, two species for comparison are employed. This allows it to obtain more information for comparison than in cases of employing only one species for comparison, which may improve the reliability of values of the first and the second statistics. This also allows the computational complexity to be reduced compared to cases of employing three or more species for comparison, which may improve the efficiency of motif finding.

An embodiment of the present disclosure has been described above, but the present disclosure is not limited thereto and can be variously modified based on the technical concept of the present disclosure.

For example, in the above embodiment, it has been described that the information processor 100 has the list acquisition unit 110, but it is not limited thereto. For example, the extraction unit 120 may be configured to extract the plurality of sequence fragments from a list of ortholog candidates being stored in a storage medium or other devices separate from the information processor 100.

In the above embodiment, a sequence region in which a sum of PM score and MA score is greater than a predetermined value has been determined as a transcription factor binding site motif candidate, but it is not limited thereto. For example, a sequence region in which a product of PM score and MA score is greater than a predetermined value may be determined as a transcription factor binding site motif candidate. Otherwise, for example, determination of a motif candidate may be performed using other computing equations based on PM score and MA score.

In the above embodiment, the MA score represented by Formula 1 has been represented with a logarithm whose base is 10, but it is not limited thereto. For example, it may be a logarithm whose base is 2, or may be the likelihood ratio as it is without the conversion to logarithm. Further, it has been described that the absolute value of Formula 1 may be employed when the resulting value of Formula 1 is negative. Alternatively, it may be allowed to obtain a positive value by adding thereto a pseudo-frequency, for example.

Further, similar to the above, in the PM score represented by Formula 2, the base of the logarithm is not limited to 2. Alternatively, it may not need to be converted to logarithm. In addition, it may not need the addition of the pseudo-frequency, and may employ the absolute value instead. Further, in the case where occurrence frequencies of the nucleotides have a large bias, a pseudo-frequency in consideration of the bias may be added.

In the above embodiment, it has been described that two species for comparison are employed, but the number of species for comparison may be one, or may be three or more.

Further, the alignment unit 130 may be configured without first and second alignment units. For example, in the case where only one species for comparison would be used, the alignment unit 130 may be configured to perform pairwise alignment between the species of interest and the species for comparison.
In the above embodiment, higher eukaryotes were employed as a subject, but the present disclosure may also employ, for example, prokaryotes such as bacteria, yeasts, and fungi.

Furthermore, the information processing system 1 may also be configured as a personal computer or the like, including all of the information processor 100, the input device 200, and the display device 300 in one.

The present disclosure may employ the following configurations.

(1) A motif finding program for enabling an information processor to function as an information processor including:

an extraction unit configured to extract a plurality of sequence fragments as ortholog candidates upstream of the respective transcriptional start sites in a DNA sequence of a species of interest and DNA sequences of at least one species for comparison;

an alignment unit configured to perform alignment on the plurality of sequence fragments;

a calculation unit configured to calculate, using the result of the alignment, a first statistics and a second statistics,
the first statistics being based on a likelihood ratio of the likelihood that assumes the plurality of sequence fragments is orthologous versus the likelihood that assumes the plurality of sequence fragments is non-orthologous,
the second statistics representing a degree of conservation among the plurality of sequence fragments;

and a determination unit configured to determine, based on the first statistics and the second statistics, transcription factor binding site motif candidates in a sequence fragment of the species of interest.

(2) The motif finding program according to (1), in which

the determination unit is configured to determine, as a transcription factor binding site motif candidate, a sequence region in which a sum of the first statistics and the second statistics is greater than a predetermined value.

(3) The motif finding program according to (1) or (2), in which

the first statistics is represented by the logarithm of the likelihood ratio.

(4) The motif finding program according to (3), in which

the first statistics is represented by Formula 1:

$$MAscore - {log}_{10} \frac{Pr g 1 * Pr g 2 * Pr g 3 … Pr gn}{Pr r 1 * Pr r 2 * Pr r 3 * Pr rn} - {log}_{10} \frac{{\prod }_{m}^{ } Pr ( c \vert good\_alignment )}{{\prod }_{m}^{ } Pr ( c \vert random\_alignment )} ,$$

where c is a pattern of arrangement in each column within a matrix when each of the aligned sequence fragments is an arrangement in a row; and m is a length of the aligned sequence.

(5) The motif finding program according to any one of (1) to (4), in which

the second statistics is represented by occurrence frequencies of the respective nucleotides in the sequence fragment of the species of interest, calculated based on position specific scoring matrices on the result of the alignment.

(6) The motif finding program according to any one of (1) to (5), in which

the species of interest is human.

(7) The motif finding program according to (6), in which

the species for comparison are mouse and rat.

(8) The motif finding program according to any one of (1) to (7), in which

the alignment unit has
a first alignment unit configured to perform alignment on each two sequence fragments including the sequence fragment of the species of interest; and
a second alignment unit configured to perform multiple alignment on all the plurality of sequence fragments, based on the result of the alignment by the first alignment unit.
   (9) The motif finding program according to any one of (1) to (8), in which

the plurality of sequence fragments include promoter regions.

(10) An information processor including:

an extraction unit configured to extract a plurality of sequence fragments as ortholog candidates upstream of the respective transcriptional start sites in a DNA sequence of a species of interest and DNA sequences of at least one species for comparison;

an alignment unit configured to perform alignment on the plurality of sequence fragments;

a calculation unit configured to calculate, using the result of the alignment, a first statistics and a second statistics,
the first statistics being based on a likelihood ratio of the likelihood that assumes the plurality of sequence fragments is orthologous versus the likelihood that assumes the plurality of sequence fragments is non-orthologous,
the second statistics representing a degree of conservation among the plurality of sequence fragments; and

a determination unit configured to determine, based on the first statistics and the second statistics, transcription factor binding site motif candidates in a sequence fragment of the species of interest.

(11) A motif finding method including:

extracting a plurality of sequence fragments as ortholog candidates upstream of the respective transcriptional start sites in a DNA sequence of a species of interest and DNA sequences of at least one species for comparison;

performing alignment on the plurality of sequence fragments;

calculating, using the result of the alignment, a first statistics and a second statistics,
the first statistics being based on a likelihood ratio of the likelihood that assumes the plurality of sequence fragments is orthologous versus the likelihood that assumes the plurality of sequence fragments is non-orthologous,
the second statistics representing a degree of conservation among the plurality of sequence fragments; and

determining transcription factor binding site motif candidates in a sequence fragment of the species of interest, on the basis of the first statistics and the second statistics.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A motif finding program for enabling an information processor to function as an information processor comprising:
an extraction unit configured to extract a plurality of sequence fragments as ortholog candidates upstream of the respective transcriptional start sites in a DNA sequence of a species of interest and DNA sequences of at least one species for comparison;
an alignment unit configured to perform alignment on the plurality of sequence fragments;
a calculation unit configured to calculate, using the result of the alignment, a first statistics and a second statistics,
the first statistics being based on a likelihood ratio of the likelihood that assumes the plurality of sequence fragments is orthologous versus the likelihood that assumes the plurality of sequence fragments is non-orthologous,
the second statistics representing a degree of conservation among the plurality of sequence fragments;
and a determination unit configured to determine, based on the first statistics and the second statistics, transcription factor binding site motif candidates in a sequence fragment of the species of interest.

2. The motif finding program according to claim 1, wherein
the determination unit is configured to determine, as a transcription factor binding site motif candidate, a sequence region in which a sum of the first statistics and the second statistics is greater than a predetermined value.

3. The motif finding program according to claim 1, wherein
the first statistics is represented by the logarithm of the likelihood ratio.

4. The motif finding program according to claim 3, wherein
the first statistics is represented by Formula 1:
$$MAscore - {log}_{10} \frac{Pr g 1 * Pr g 2 * Pr g 3 … Pr gn}{Pr r 1 * Pr r 2 * Pr r 3 * Pr rn} - {log}_{10} \frac{{\prod }_{m}^{ } Pr ( c \vert good\_alignment )}{{\prod }_{m}^{ } Pr ( c \vert random\_alignment )} ,$$
where c is a pattern of arrangement in each column within a matrix when each of the aligned sequence fragments is an arrangement in a row; and m is a length of the aligned sequence.

5. The motif finding program according to claim 1, wherein
the second statistics is represented by occurrence frequencies of the respective nucleotides in the sequence fragment of the species of interest, calculated based on position specific scoring matrices on the result of the alignment.

6. The motif finding program according to claim 1, wherein
the species of interest is human

7. The motif finding program according to claim 6, wherein
the species for comparison are mouse and rat.

8. The motif finding program according to claim 1, wherein
the alignment unit has
a first alignment unit configured to perform alignment on each two sequence fragments including the sequence fragment of the species of interest; and
a second alignment unit configured to perform multiple alignment on all the plurality of sequence fragments, based on the result of the alignment by the first alignment unit.

9. The motif finding program according to claim 1, wherein
the plurality of sequence fragments include promoter regions.

10. An information processor comprising:
an extraction unit configured to extract a plurality of sequence fragments as ortholog candidates upstream of the respective transcriptional start sites in a DNA sequence of a species of interest and DNA sequences of at least one species for comparison;
an alignment unit configured to perform alignment on the plurality of sequence fragments;
a calculation unit configured to calculate, using the result of the alignment, a first statistics and a second statistics,
the first statistics being based on a likelihood ratio of the likelihood that assumes the plurality of sequence fragments is orthologous versus the likelihood that assumes the plurality of sequence fragments is non-orthologous,
the second statistics representing a degree of conservation among the plurality of sequence fragments; and
a determination unit configured to determine, based on the first statistics and the second statistics, transcription factor binding site motif candidates in a sequence fragment of the species of interest.

11. A motif finding method comprising:
extracting a plurality of sequence fragments as ortholog candidates upstream of the respective transcriptional start sites in a DNA sequence of a species of interest and DNA sequences of at least one species for comparison;
performing alignment on the plurality of sequence fragments;
calculating, using the result of the alignment, a first statistics and a second statistics,
the first statistics being based on a likelihood ratio of the likelihood that assumes the plurality of sequence fragments is orthologous versus the likelihood that assumes the plurality of sequence fragments is non-orthologous,
the second statistics representing a degree of conservation among the plurality of sequence fragments; and
determining transcription factor binding site motif candidates in a sequence fragment of the species of interest, on the basis of the first statistics and the second statistics.


SEQUENCE LISTING (15 sequences)

SEQ ID NO: 1 - DNA, 118 bp, Artificial Sequence
  Synthesized NM_027915 Partial Sequence
ctcctagttcatccgtccgtctgtagtcctgttaaccttacaagcaaattagctgagcttgtgcacacaggtttcacaaaaatctttaccacttattgaagatatccggtggaaagca

SEQ ID NO: 2 - DNA, 126 bp, Artificial Sequence
  Synthesized NM_080583 Partial Sequence
gctaactcctagttcagctgcccacctgtacttctgtgaaccttacatgcaaattagccgaggtttgtgcacacaggtttaacaaaattctttatctacgtattgaagatatcctttggaaaagcc

SEQ ID NO: 3 - DNA, 143 bp, Artificial Sequence
  Synthesized NM_001282 Partial Sequence
actatcctctagccccactgcccgtatataggcctgtgagcctggaaggaaaatgagctgaggggttttgttcatcatctctatgttacgtttttcagagaattcttgtcagctttttttaaaatatatcctttggagtagcc

SEQ ID NO: 4 - DNA, 450 bp, Artificial Sequence
  Synthesized NM_172232 Human Sequence Chr17
agtatcttagtgcgcagacgtccttcctgcgaagggcgcgaaggccgctgggtaatgtagttctccggcggagtccacggggctctgatttaaggaaacgtggtcgccccggtcgctgagcgagataactgggtgcgacaaagattgcgtccagataaacaagtcagacacacactcagtagagtgatgggtgaaaagcggcaaggccaagacggggcggcagttttgttctcgaaaagcctctgaaacaacagctaaagaatattaggttagctaaagagcttttggcttgtcgagaaggtctgtttgggagtttagtgtgttgattttgcagctcagcacctgttgtgctgttcttgcctgtagacgttttaccctcacacctccgnnnnnnnnnnnnnnnnnnnnnnnnnnnnnnnnnnnnnnnnnnnnnnnnnnnnnnnnnnnnnn

SEQ ID NO: 5 - DNA, 500 bp, Artificial Sequence
  Synthesized NM_147219 Mouse Chr 11
agtatcttagtgcgcagacgtccttcctgcgaaaggcgcgaggcctgctgggtagtgtagttctcctgtagagtccacgcgtctctgatttaaggaaacgtgctcctgtaggtggctgagctagatgactgactaagcgcgacagagatccagataaacatcgcacgtacactctttagtaagggaagggtgacaaacagcgcggtccatgataggaggctttttctgttctagaaaaacccctgaatcaacagcttagagagcacaggggtagcgaagacgcttttggcacccctagactaaggtctaattgggggttcaatgtggctttttttttttttaaaccggctcagtatctgtgaactgctctgtctgtagaccgttcaccctgacatctcatttcacaacaaacatttttcttgaatggagatttttggggtgatttgactcttcagacaagatacaaagnnnnnnnnnnnnnnnnnnnnnnnnnaataaga

SEQ ID NO: 6 - DNA, 800 bp, Artificial Sequence
  Synthesized NM_173307 Rat Chr. 10
gcaagtggagtttctcttgaccgatgcagcagatggactttcagggagtcaagatggaattgcacaccttgcaaaacagtctggaaagtgatttttcccccaattgcaacgttagggaaggctgtgctgcagctacatgatgggccagggctggcagctaaaagctccaaacttggaactgagtatcttagtgcgcagacgtccttcctgcgaaaggcgcgaggcctgctgggtaatgtagttctcctgtagagtccacgcgtctctgatttaaggaaacgtgctcctgtaggtggctgagccagatgactgactaagcgcgacagagatctcagataaacatcagacatacactctttagtaagggaagggtgacaaacagcacggttcacgaaagaaggctttttgtttgtttgttctagaaaaaaccctgaatcaacagtttagagaacacaggggtagctaaggcgcttttgacaccccagactaaggtctaattgggggttcgacgtgttaattttttttaaccggctcagtgtctgtgaactgttctgcctatagaaccgttcaccctgacgcctcatttcacaacaaacatttttcttgaatggagattctggtggtgatctggcccttggaacagcatacaaagttttatttattaagaagcgatccgggtcaattcttttcaagaaaactgaaatccaatgctggatagggccgagggagagagatttaggaagtttctcatttcttacagggttagacaggaannnnnnnnnnnnnnnnnnnnnnnnnnn

SEQ ID NO: 7 - DNA, 87 bp, Artificial Sequence
  Synthesized Partial NM_172232 Human Sequence Chr. 17
ttggttgattactctctccaccaacttcccctgaagttctcctatctttgggggcacagttctgcctaaactcgtctctgtcacatt

SEQ ID NO: 8 - DNA, 71 bp, Artificial Sequence
  Synthesized Partial NM_147219 Mouse Sequence Chr. 11
ttaaaatataaaactgtgacctaagaatagtaacccggctttatccagactgtctaaatgatatgtatatt

SEQ ID NO: 9 - DNA, 72 bp, Artificial Sequence
  Synthesized Partial  NM_173307 Rat Sequence Chr. 10
ttaaaacattaaaactatgacgtaagaatactaactcatctttatcaagactactcaaatgacatgtatatt

SEQ ID NO: 10 - DNA, 23 bp, Artificial Sequence
  Synthesized Human Promoter
gagctagacgtccgggcagcccc

SEQ ID NO: 11 - DNA, 23 bp, Artificial Sequence
  Synthesized Mouse Promoter
taactagacgtctgggcagcccc

SEQ ID NO: 12 - DNA, 23 bp, Artificial Sequence
  Synthesized Rat Promoter
tagctagacgcctggacagcccc

SEQ ID NO: 13 - DNA, 10 bp, Artificial Sequence
  Synthesized NPY Promoter 1
ggcgggtggg

SEQ ID NO: 14 - DNA, 9 bp, Artificial Sequence
  Synthesized NPY Promoter 2
ggctgtggg

SEQ ID NO: 15 - DNA, 9 bp, Artificial Sequence
  Synthesized NPY Promoter 3
aggggcggg